(19) United States
(12) Patent Application Publication
(10) Pub. No.: US 2026/0257853 A1
(43) Pub. Date: Sep. 3, 2026

(54) TISSUE BOX WITH INTEGRATED TRASH CAN

(71) Applicant: Adrian Lekaj, Washington, MI (US)

(72) Inventor: Adrian Lekaj, Washington, MI (US)

(21) Appl. No.: 19/067,946

(22) Filed: Mar. 2, 2025

(51) Int. Cl. B65D 83/08; B65F 1/12

(52) U.S. Cl. CPC B65D 83/0888; B65D 83/0835; B65F 1/12; B65D 2209/00

(57) ABSTRACT

The invention is a tissue box with an integrated trash compartment, enabling convenient disposal of used tissues in a single compact unit. The design consists of a tissue dispensing system and a waste management system combined within a single housing. The structure eliminates the need for a separate trash bin and is suitable for use in cars, on desks, and other small spaces. The integrated system enhances cleanliness and convenience in environments where tissue use is frequent.

### OBJECTS AND ADVANTAGES OF THE INVENTION

The present invention substantially departs from the conventional concepts and designs of the prior art. In doing so, the present invention provides (a or an) tissue box with integrated trash can, having many unique and significant features, functions, and advantages, which overcome all the disadvantages of the prior art, as follows:
1) It is an object of the new invention to provide (a or an) tissue box with integrated trash can, having core 107.
   Therefore, the tissue box with integrated trash can is (or are each):
      a) Capable of supporting overall structure;
      b) Capable of integrating tissue dispensing and waste disposal into one unit; and
      c) Capable of eliminating need for a separate trash bin.

### BRIEF DESCRIPTION OF THE DRAWINGS

FIG. 1 illustrates a (or an) isometric view of core core 107.

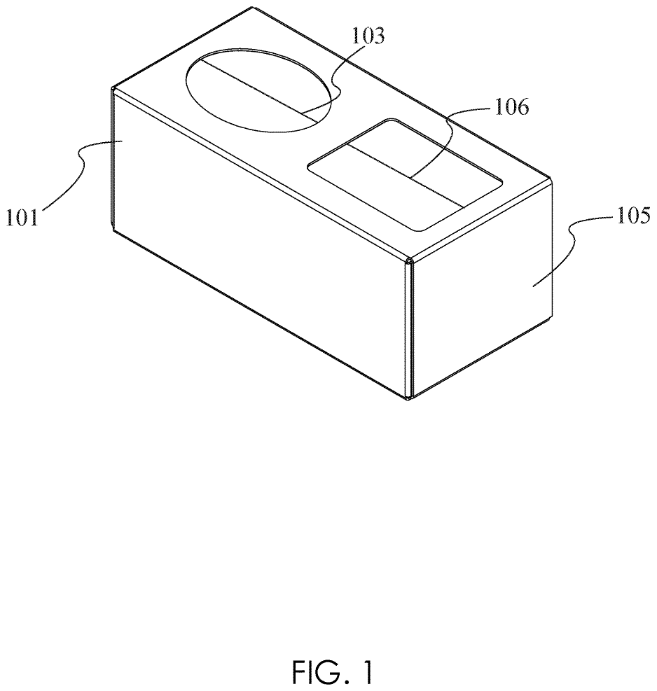

FIG. 2 illustrates a (or an) isometric view of core 107.

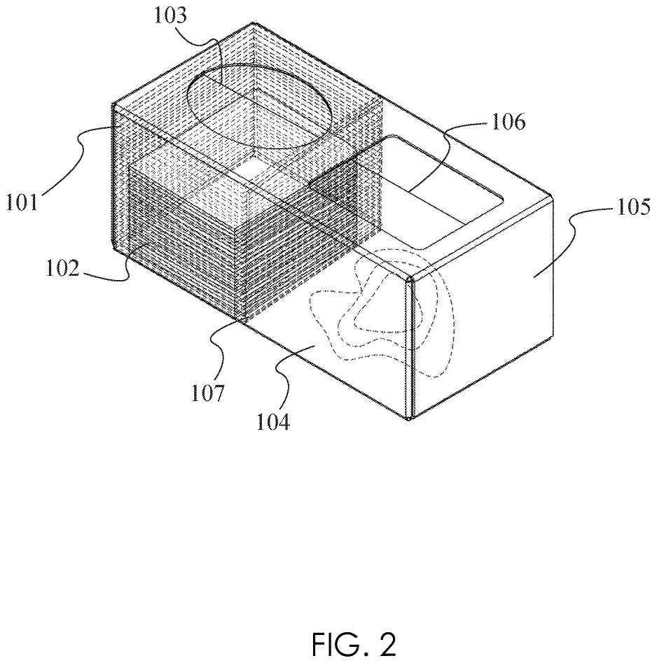

FIG. 3 illustrates a (or an) isometric view of core 107.

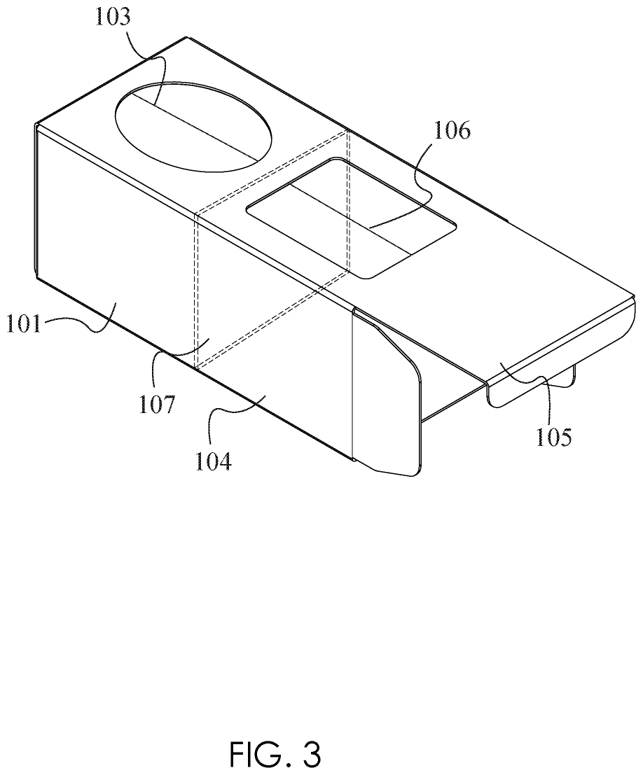

FIG. 4 illustrates a (or an) top view of core 107.

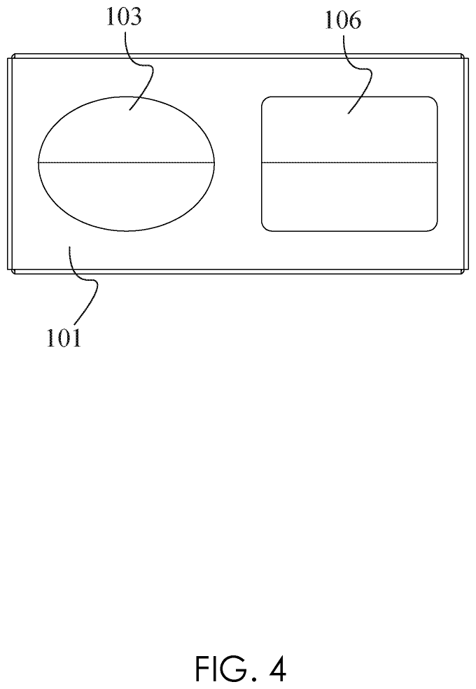

FIG. 5 illustrates a (or an) top view of core 107.

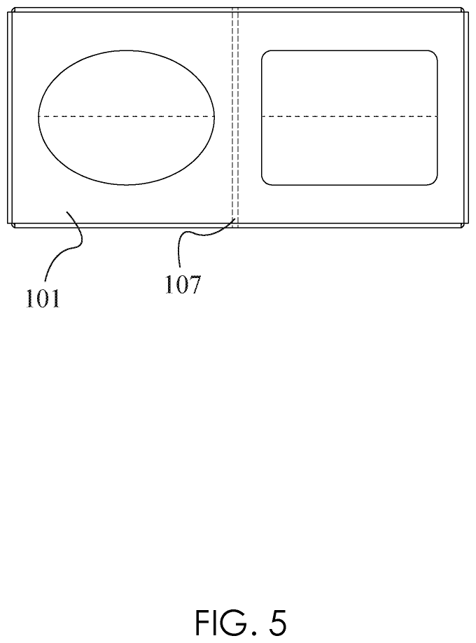

FIG. 6 illustrates a (or an) bottom view of core 107.

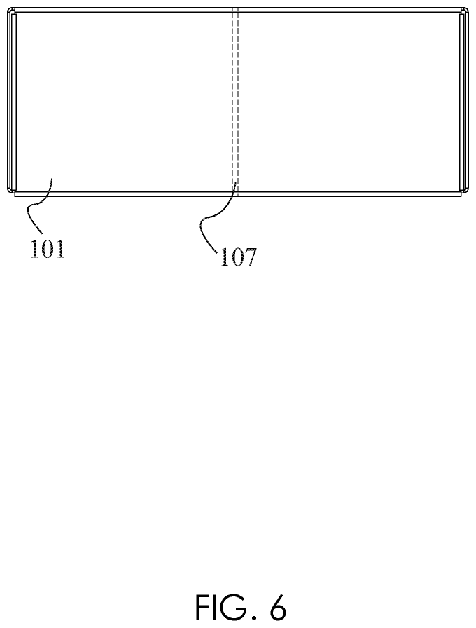

FIG. 7 illustrates a (or an) side view of core 107.

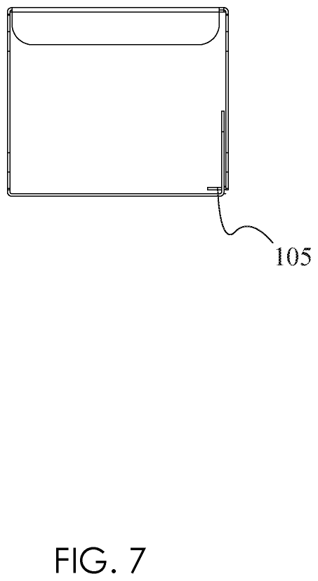

### DETAILED DESCRIPTION OF THE INVENTION

### Component

The tissue box with integrated trash can comprises:
1) Tissue dispensing system(s) 101 comprising (or each comprising):
2) Tissue stack 102, and
3) Plastic lip 103; and
4) Waste management system(s) 104 comprising (or each comprising):
5) Disposal Flap 105, 6) Plastic Lip 106, and 7) Core 107.

### Material

1) Tissue dispensing system(s) 101 is (or are each) made of the combined materials of its components.
2) Tissue stack 102 is (or are each) made of the material of recycled pulp.
3) Plastic lip 103 is (or are each) made of the material of plastic.
4) Waste management system(s) 104 is (or are each) made of the combined materials of its components.
5) Disposal flap 105 is (or are each) made of the material of cardboard.
6) Plastic lip 106 is (or are each) made of the material of plastic.
7) Core 107 is (or are each) made of the material of cardboard.

### Shape

1) Tissue dispensing system(s) 101 is (or are each) formed into the combined shapes of its components.
2) Tissue stack 102 is (or are each) formed into the shape of (a or an) cube.
3) Plastic lip 103 is (or are each) formed into the shape of (a or an) rectangle.
4) Waste management system(s) 104 is (or are each) formed into the combined shapes of its components.
5) Disposal flap 105 is (or are each) formed into the shape of (a or an) cube.
6) Plastic lip 106 is (or are each) formed into the shape of (a or an) rectangle.
7) Core 107 is (or are each) formed into the shape of (a or an) rectangular prism.

### Connection

1) Tissue dispensing system(s) 101 is (or are respectively) connected by the combined connections of its components.
2) Tissue stack 102 is (or are respectively) placed inside core.
3) Plastic lip 103 is (or are respectively) taped to inner ceiling.
4) Waste management system(s) 104 is (or are respectively) connected by the combined connections of its components.
5) Disposal flap 105 is (or are respectively) hinged to side of waste compartment.
6) Plastic lip 106 is (or are respectively) taped to inner ceiling.
7) Core 107 is (or are respectively) formed as single structure with box.

### Function

1) Tissue dispensing system(s) 101 is (or are respectively) for performing the combined functions of its components.
2) Tissue stack 102 is (or are respectively) for:
a) Providing tissues for use.
3) Plastic lip 103 is (or are respectively) for:
a) Guiding tissues for easy dispensing.
   4) Waste management system(s) 104 is (or are respectively) for performing the combined functions
      of its components.
5) Disposal flap 105 is (or are respectively) for:
a) Allowing access to trash compartment for disposal.
6) Plastic lip 106 is (or are respectively) for:
a) Securing waste compartment.
7) Core 107 is (or are respectively) for:
a) Supporting overall structure;
b) Integrating tissue dispensing and waste disposal into one unit; and
c) Eliminating need for a separate trash bin.

### MAJOR ADVANTAGES OF THE INVENTION

The present invention substantially departs from the conventional concepts and designs of the prior art. In doing so, the present invention provides (a or an) tissue box with integrated trash can, having many unique and significant features, functions, and advantages, which overcome all the disadvantages of the prior art, as follows:
1) It is an object of the new invention to provide (a or an) tissue box with integrated trash can, having core 107.
   Therefore, the tissue box with integrated trash can is (or are each):
      a) Capable of supporting overall structure;
      b) Capable of integrating tissue dispensing and waste disposal into one unit; and
      c) Capable of eliminating need for a separate trash bin.

I claim:

1. A dual-purpose container comprising: a tissue dispensing compartment configured to hold and dispense facial tissues; and an integrated trash receptacle positioned adjacent to the tissue compartment, configured to receive discarded tissues.
